(19) United States
(12) Patent Application Publication
(10) Pub. No.: US 2012/0233420 A1
(43) Pub. Date: Sep. 13, 2012

(54) FAULT-TOLERANT SYSTEM, MEMORY CONTROL METHOD, AND COMPUTER-READABLE RECORDING MEDIUM STORING PROGRAMS

(75) Inventor: Junichi MATSUSHITA, Tokyo (JP)

(73) Assignee: NEC Corporation, Tokyo (JP)

(21) Appl. No.: 13/413,558

(22) Filed: Mar. 6, 2012

(30) Foreign Application Priority Data
Mar. 9, 2011 (JP) 2011-051757

(51) Int. Cl. G06F 12/16

(52) U.S. Cl. 711/162; 711/E12.103

(57) ABSTRACT

The object is to prevent the processing of a fault-tolerant computer from slowing down. The memory of the active system comprises a memory table and a transfer table. When data stored in the memory table are updated, the updated data are stored also in the transfer table. When data are transferred from the transfer table to the standby system, only update of data stored in the transfer table is restricted. The memory table is continuously used as the work area for normal operation. Consequently, slowing down in the processing of a fault-tolerant computer due to restriction on update of data stored in the memory is prevented.

### CROSS-REFERENCE TO RELATED APPLICATION

This application claims the benefit of Japanese Patent Application 2011-051757, filed on Mar. 9, 2011, the entire disclosure of which is incorporated by reference herein.

### FIELD

This application relates to a fault-tolerant system, memory control method, and computer-readable recording medium storing programs.

### BACKGROUND

An active-standby scheme is employed for realizing a fault-tolerant computer, namely a computer highly tolerant to faults (hereafter referred to as an FT computer). A typical active-standby scheme utilizes two systems having the same configuration; one is active and in operation and the other is on standby and waits for ready. In such a scheme, when a failure occurs on the system in operation (hereafter referred to as the active system), the working system is switched to the system on standby (hereafter referred to as the standby system).

The memory of the standby system is updated at each checkpoint so as to store the same data as in the memory of the active system. The checkpoint can be any point defined in a program, or a given stage in the course of processing of the active system. More specifically, first, after the memories of the active and standby systems are set to the same initial state, update of data stored in the active system is monitored. Then, at each checkpoint, the updated data among data stored in the active system memory are transferred to the standby system and written in the memory of the standby system (reference is made, for example, to Unexamined Japanese Patent Application Kokai Publication Nos. H02-165344 and 2001-188690).

### SUMMARY

However, in the above technique, in order to prevent data stored in the active system memory from being updated while being transferred to the standby system, the data update is restricted. Therefore, if data are transferred frequently, restricted update of data stored in the memory may slow down the processing of the FT computer.

The present invention has been invented in view of the above problem and an exemplary object of the present invention is to prevent the processing of a FT computer from slowing down.

In order to achieve the above objective, the fault-tolerant system according to a first exemplary aspect of the present invention comprises:

a first storer storing data in a first storage region of memory;

a second storer storing updated data in a second storage region different from the first storage region when data stored in the first storage region are updated;

a transferer transferring data stored in the second storage region to another system; and

a restrictor restricting update of data in the second storage region during transfer by the transferer.

In order to achieve the above object, the memory control method according to a second exemplary aspect of the present invention includes:

a first storing step of storing data in a first storage region of a memory;

a second storing step of storing updated data in a second storage region different from the first storage region when data stored in the first storage region are updated;

a transfer step of transferring data stored in the second storage region to another system; and

a restriction step of restricting update of data in the second storage region during transfer in the transfer step.

In order to achieve the above objective, the program stored on a computer-readable recording medium according to a third exemplary aspect of the present invention allows a computer to function as:

a first storer storing data in a first storage region of a memory;

a second storer storing updated data in a second storage region different from the first storage region when data stored in the first storage region are updated;

a transferer transferring data stored in the second storage region to another system; and

a restrictor restricting update of data in the second storage region during transfer by the transferer.

The present invention stores data in two different regions on a memory and restricts only update of data stored in one region. Therefore, a FT computer can update data stored in the other region without interruptions. Consequently, the processing of the FT computer does not slow down.

### BRIEF DESCRIPTION OF THE DRAWINGS

A more complete understanding of the application can be obtained when the following detailed description is considered in conjunction with the following drawings, in which:

FIG. 1 is a block diagram showing the hardware configuration of a FT computer according to an embodiment;

FIG. 2 is a diagram showing the structure of the active system memory;

FIG. 3 is a flowchart showing the procedure executed by the active system processor for controlling the memory;

FIG. 4 is a diagram showing the memory receiving an instruction to update data;

FIG. 5 is a diagram showing a transfer page in which data are copied from a memory page;

FIG. 6 is a diagram showing the memory receiving an instruction to update the data in the memory page again;

FIG. 7 is a diagram showing transfer at a checkpoint; and

FIG. 8 is a diagram showing the memory after the transfer at a checkpoint is completed.

### DETAILED DESCRIPTION

An embodiment of the present invention is described hereafter with reference to the drawings.

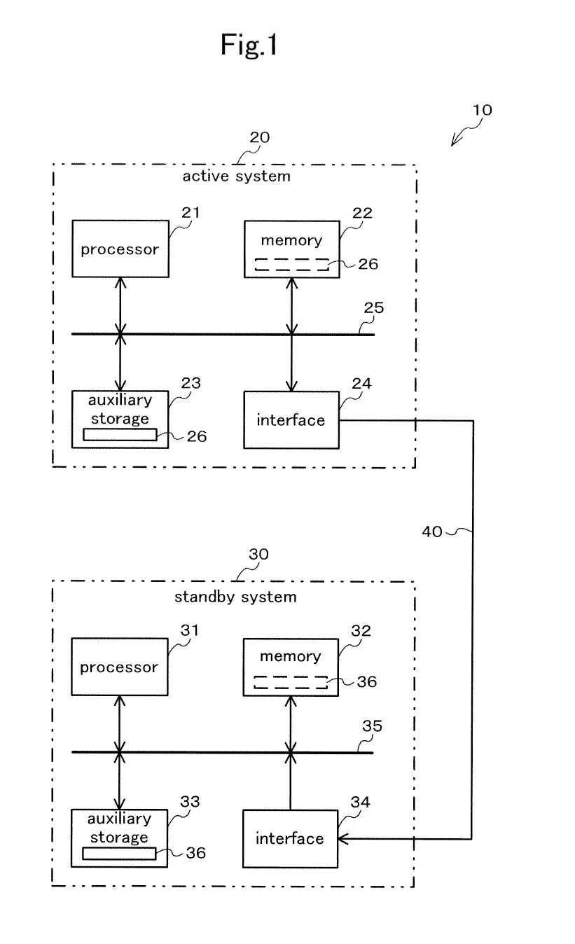

FIG. 1 shows the hardware configuration of a FT computer 10 according to this embodiment. As shown in FIG. 1, the FT computer 10 comprises an active system 20, a standby system 30, and a transmission line 40.

The active system 20 is a system with which the FT computer 10 normally operates. The active system 20 is designed with consideration for possible failures. The active system 20 is composed of a processor 21, a memory 22, an auxiliary storage 23, an interface 24, etc. The memory 22, auxiliary storage 23, and interface 24 are all connected to the processor 21 via an internal bus 25.

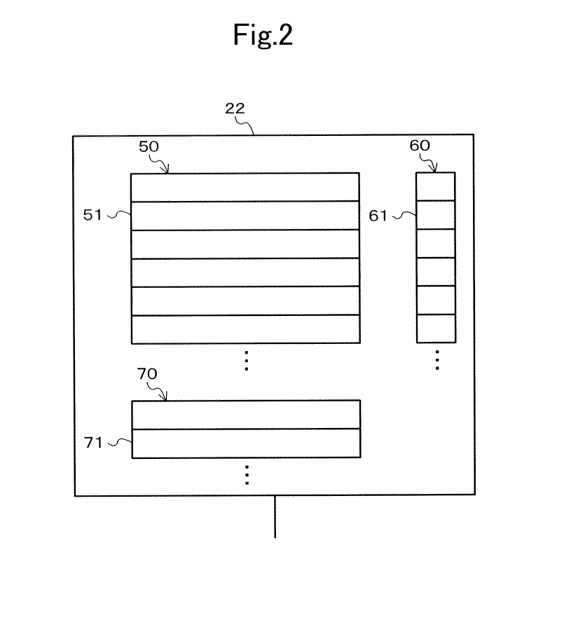

The memory 22 is composed of RAM (random access memory) or the like. With programs 26 stored in the auxiliary storage 23 being loaded, the memory 22 is used as the work area of the processor 21. As shown in FIG. 2, the memory 22 has a memory table 50, a state table 60, and a transfer table 70.

The memory table 50 consists of multiple memory pages 51. The memory pages 51 store programs to be executed by the processor 21 and data. Hereafter, information stored in the memory pages 51 is referred to simply as data.

The state table 60 consists of multiple state pages 61. Each state page 61 corresponds to one of the memory pages 51 and stores a state flag indicating the state of the corresponding memory page 51. The state of a memory page 51 is either a “dirty” state indicating that the data are updated after a checkpoint or a “clean” state indicating that the data are not updated after a checkpoint.

The transfer table 70 consists of multiple transfer pages 71. The transfer pages 71 store data copied from the memory pages 51. The data stored in the transfer pages 71 are transferred to the standby system 30.

The processor 21 is composed of a CPU (central processing unit) or the like, and executes various procedures according to the programs 26 stored in the auxiliary storage 23. Furthermore, the processor 21 is provided with the function of a memory controller. In other words, the processor 21 reads/writes data from/in the memory 22. Here, the processor 21 controls the memory 22 on a page basis.

The page in this embodiment includes a memory page 51, a state page 61, and a transfer page 71. A page is a unit used not only by FT computers but also by conventional computers for exchanging data between a main memory and a hard disc in a virtual memory paging system. In other words, as the programs 26 are executed, the memory 22 is updated on a page basis. Using the equal unit for update and transfer to the standby system 30, only updated data can be transferred to the standby system 30.

The auxiliary storage 23 is composed of a nonvolatile memory such as a flush drive and hard disc, and pre-stores the programs 26 to be executed by the processor 21. Furthermore, the auxiliary storage 23 supplies data stored by the programs 26 to the processor 21 and stores data supplied from the processor 21 according to instructions from the processor 21.

The interface 24 is connected to the standby system 30 via the transmission line 40. The interface 24 relays data transmitted by the processor 21 to the standby system 30.

The standby system 30 is a backup system used when the active system 20 fails. The standby system 30 is composed of a processor 31, a memory 32, an auxiliary storage 33, an interface 34, etc. The memory 32, auxiliary storage 33, and interface 34 are all connected to the processor 31 via an internal bus 35.

The processor 31 is composed of a CPU or the like, and executes various procedures according to programs 36 stored in the auxiliary storage 33. Furthermore, the processor 31 is provided with the function of a memory controller.

The memory 32 is composed of RAM or the like. With the programs 36 stored in the auxiliary storage 33 being loaded, the memory 32 is used as the work area of the processor 31. The memory 32 stores data transferred from the active system 20 via the transmission line 40 and interface 34 at each checkpoint.

The auxiliary storage 33 is composed of nonvolatile memory such as a flush drive and hard disc, and pre-stores the programs 36 to be executed by the processor 31. Furthermore, the auxiliary storage 33 supplies data stored by the programs 36 to the processor 31 and stores data supplied from the processor 31 according to instructions from the processor 31.

The interface 34 is connected to the active system 20 via the transmission line 40.

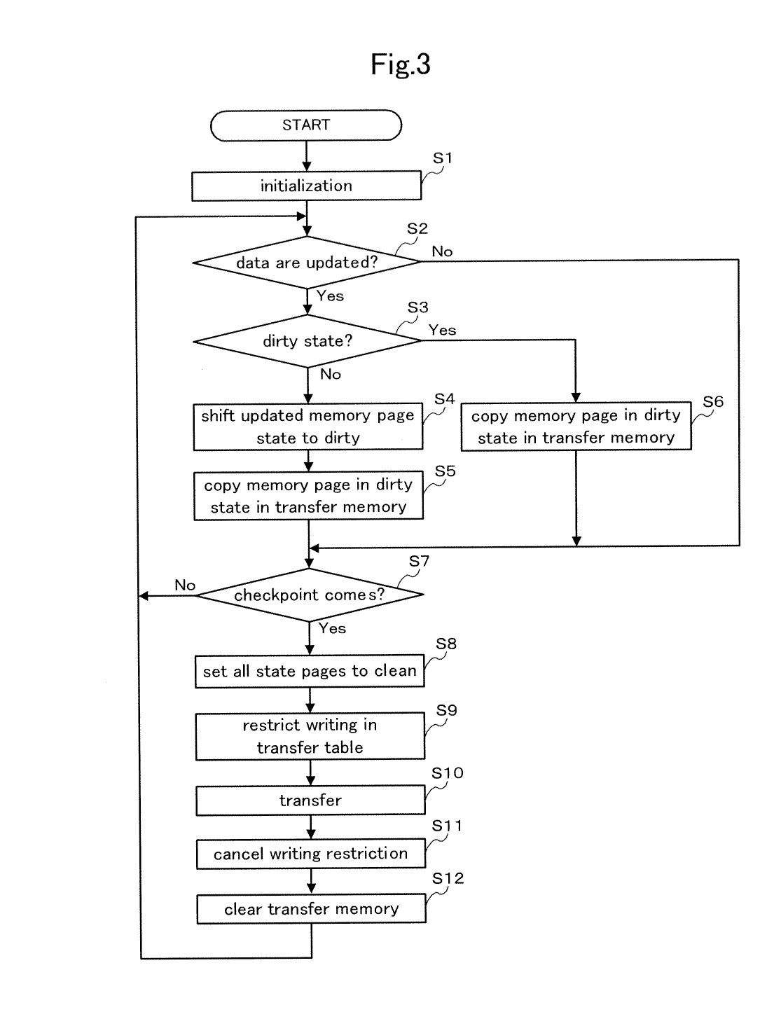

The FT computer 10 having the above components transfers data at each checkpoint so that the same data are stored in the memory table 50 and memory 32. Procedures relating to this transfer are described hereafter with reference to FIGS. 3 to 8.

First, the FT computer 10 is initialized (Step S1). More specifically, the FT computer sets the memory table 50 and memory 32 to an equal state during initialization. For example, the processors 21 and 31 cooperate to clear data in the memory table 50 and memory 32. Furthermore, the processor 21 sets all state flags stored in all state pages 61 to “clean.”

Then, the processor 21 determines whether data in a memory page 51 are updated (Step S2). If no data in any memory page 51 are updated (Step S2; No), the process proceeds to Step S7. If data in a memory page 51 are updated (Step S2; Yes), the processor 21 determines whether the memory page 51 having the data updated is in the “dirty” state (Step S3).

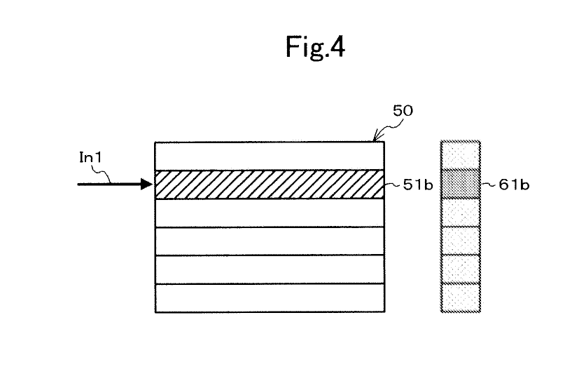

If the memory page 51 is not in the “dirty” state (Step S3; No), the processor 21 shifts the state of the memory page 51 having the data updated to the “dirty” state. In order words, the processor 21 selects the state page 61 corresponding to the memory page 51 having the data updated and sets the state flag stored in that state page 61 to the “dirty” (Step S4). For example, as shown in FIG. 4, if there is an instruction In1 to update the data in the memory page 51b, the processor 21 changes the state flag stored in the state page 61b from the “clean” to “dirty.” Here, the state page 61b corresponds to the memory page 51b.

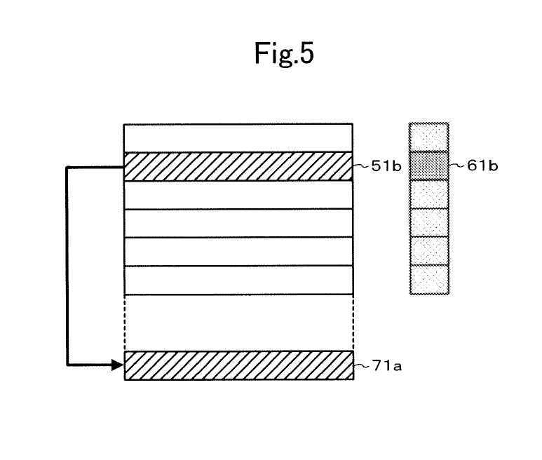

Then, the processor 21 copies the data stored in the memory page 51 in the “dirty” state in the transfer page 71 (Step S5). For example, as shown in FIG. 5, if the state flag stored in the state page 61b is “dirty,” the processor 21 copies the data in the memory page 51b in a transfer page 71a.

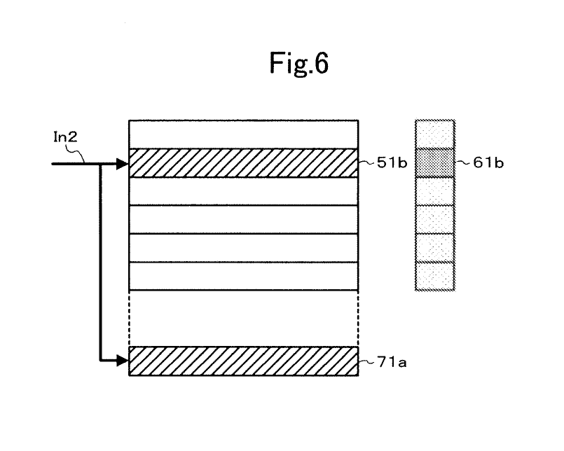

On the other hand, if the memory page 51 is in the “dirty” state (Step S3; Yes), the processor 21 stores and updates the data according to the instruction in the memory page 51 and the transfer page 71 corresponding to the memory page 51 (Step S6). For example, as shown in FIG. 6, if there is an instruction In2 to update the data in the memory page 51b in the “dirty” state, the processor 21 updates the data in the memory page 51b and in the transfer page 71a.

Then, the processor 21 determines whether a checkpoint has come (Step S7). For example, the processor 21 determines whether there is an instruction to transfer data stored in the memory table 50 to the standby system 30 in the procedure executed by a program such as an OS (operating system).

If a checkpoint has not come (Step S7; No), the processor 21 repeats the processing in the Steps S2 to S7.

If a checkpoint has come (Step S7; Yes), the processor 21 sets the state flags stored in all state pages 61 to the “clean.” (Step S8).

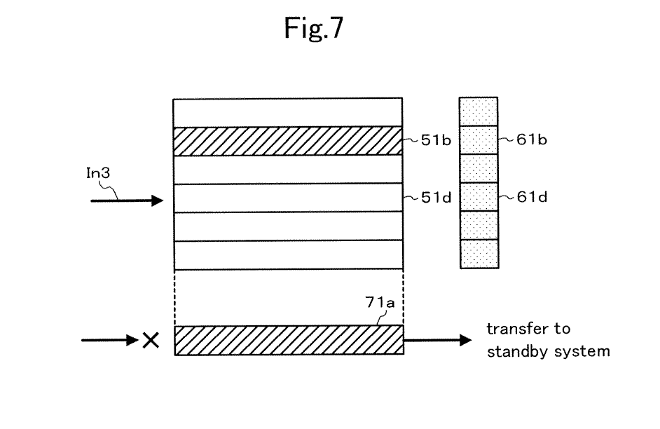

Furthermore, the processor 21 restricts update of data stored in the transfer table 70 (Step S9). Here, update of data stored in the memory table 50 is not restricted. Therefore, the processor 21 operates normally using the memory table 50 as the work area. For example, as shown in FIG. 7, if there is an instruction In3 to update data in the memory page 51d, the processor 21 can update data stored in the memory page 51d.

Then, the processor 21 transfers the data in the transfer page 71 to the memory 32 of the standby system 30 (Step S10). Consequently, the same data as in the memory page 51b are stored in the memory 32 of the standby system 30 at the checkpoint.

Subsequently, the processor 21 cancels the restriction on update of data stored in the transfer table 70 (Step S11).

Furthermore, the processor 21 clears all data stored in the transfer table 70 (Step S12).

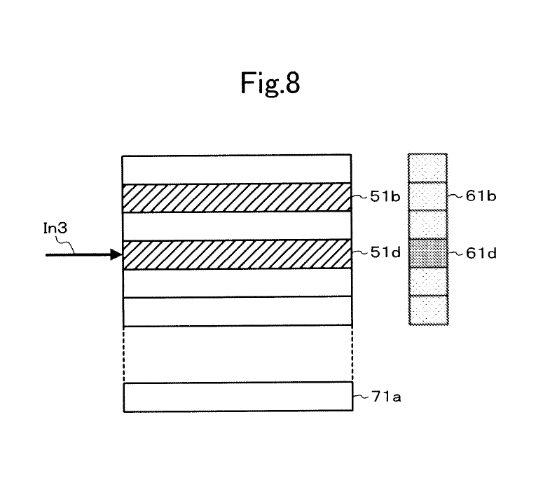

Then, the processor 21 repeats the processing in the Steps S2 to S12. For example, as shown in FIG. 8, if there is an instruction In3 to update data in the memory page 51d, the processor 21 sets the state flag stored in the state page 61d to the “dirty” (Step S4). Then, the processor 21 executes the procedure to update data stored in the memory 50 and transfer table 70 and the procedure to transfer data at a checkpoint.

As described above, the active system 20 according to this embodiment stores data updated after initialization or after a checkpoint in the memory table 50 and transfer table 70. In other words, the active system 20 stores the same data in two regions of the memory 22. Here, the processor 21 can execute the procedure to copy data stored in the memory page 51 in the “dirty” state in the transfer page 71 (Step S5) at a time when a checkpoint has come (Step S7; Yes). If the same memory page 51 is updated multiple times, the data to be transferred to the standby system 30 at a time of checkpoint are the data in the memory page 51 after the last update. If the procedure to copy in the transfer page 71 is conducted at a time when a checkpoint has come, the procedure to update the transfer table 70 in the Step S6 can be eliminated, reducing the workload of the active system 20.

Furthermore, the active system 20 restricts only update of data stored in the transfer table 70 during data transfer. Consequently, the processor 21 can continue to process using the memory table 50 while data are transferred at each checkpoint. Then, slowing down in the processing of the TF computer 10 at checkpoints will be prevented.

Furthermore, data updated by the next checkpoint since a given checkpoint are copied in the transfer table 70 and transferred to the standby system 30. In other words, among the memory pages 51 of the memory table 50, only the updated memory pages 51 are transferred. Therefore, the active system 20 can reduce the volume of data transferred to the standby system 30.

Furthermore, the processor 21 clears the data in the transfer pages 71 that have been transferred. Consequently, the processor 21 does not need to determine which data should be transferred to the standby system 30 among the data stored in the transfer table 70. Then, the active system 20 can execute the transfer process in a simple manner at a high speed.

Furthermore, the processor 21 controls the memory 22 on a page basis. In other words, the processor 21 copies data in the transfer table 70 on the basis of the memory page 51 and transfers data to the standby system 30 on the basis of the transfer page 71. Therefore, the processor 21 can execute the procedure regarding the transfer and the normally executed procedures on the same unit memory region basis, efficiently executing various procedures.

Furthermore, the state page 61 stores a state flag indicating whether the memory page 51 is updated after a given checkpoint. Making reference to the state page 61, the processor 21 can determine which memory page 51 stores data that should be copied.

An embodiment of the present invention is described above. The present invention is not confined to the above embodiment.

For example, the processor 21 according to the above embodiment has the function of a memory controller. An independent circuit as a memory controller can be provided to the active system or to the standby system.

For example, the processor 21, memory 22, auxiliary storage 23, and interface 24 according to the above embodiment are connected via an internal bus 25. They can be connected via a chip set or bridge circuit.

For example, the processor 21 according to the above embodiment executes the procedure to copy on the basis of the memory page 51. The processor 21 can do the procedure on the basis of the memory table 50.

Furthermore, the functions of the active system 20 and standby system 30 according to the above embodiment can also be realized by dedicated hardware or a conventional computer system.

For example, the programs stored in the auxiliary storage 23 of the active system 20 or in the auxiliary storage 33 of the standby system 30 in the above embodiment can be stored and distributed on a computer readable recording medium such as a flexible disk, CD-ROM (compact disk read-only memory), DVD (digital versatile disk), and MO (magneto-optical disk); then, the programs are installed on a computer to configure a device executing the above procedures.

Furthermore, the programs can be stored in a disk device of a given server unit on a communication network such as the Internet and, for example, superimposed on carrier waves to download them onto a computer.

Furthermore, the programs can be activated and executed while being transferred via a communication network to achieve the above procedures.

Furthermore, it is possible that the programs are entirely or partly executed on a server unit and a computer executes programs while transmitting/receiving information regarding the processing via a communication network so as to achieve the above procedures.

Here, when the above functions are realized partly by an OS (operation system) or by cooperation of an OS and application programs, only the portion other than the OS can be stored and distributed on a medium, or downloaded onto a computer.

The above embodiment will partly or entirely be described as in the following subjunction, but not restricted thereto.

(Subjunction 1)

A fault-tolerant system, comprising:

a first storer storing data in a first storage region of a memory;

a second storer storing updated data in a second storage region different from the first storage region when data stored in the first storage region are updated;

a transferer transferring data stored in the second storage region to another system; and

a restrictor restricting update of data in the second storage region during transfer by the transferer.

(Subjunction 2)

The fault-tolerant system according to Subjunction 1, wherein:

the second storer stores in the second storage region data in the first storage region that are updated by the next checkpoint since a given checkpoint; and

the transferer transfers data stored in the second storage region at each of the checkpoints.

(Subjunction 3)

The fault-tolerant system according to Subjunction 1 or 2, further comprising:

a clearer clearing data that have been transferred by the transferer among the data stored in the second storage region.

(Subjunction 4)

The fault-tolerant system according to any one of Subjunction 1 to 3, wherein:

the second storer stores in the second storage region data in a small region having updated data among multiple small regions constituting the first storage region; and

the transferer transfers the data in a small region that are stored in the second storage region to another system.

(Subjunction 5)

The fault-tolerant system according to Subjunction 4, further comprising:

a third storer storing flags corresponding to the small regions of the first storage region, respectively; and

a setter setting a flag corresponding to the small region having the updated data to dirty and setting the flags corresponding to the multiple small regions to clean when the restrictor restricts data update,

wherein the second storer stores in the second storage region data in the small region corresponding to the flag set to dirty.

(Subjunction 6)

The fault-tolerant system according to Subjunction 5, wherein:

the second storer

stores in the second storage region data in the small region having the flag set to dirty each time the setter sets a flag corresponding to the small region having the updated data to dirty; and

similarly updates the data in the small region that are stored in the second storage region when the data in the small region having the flag set to dirty are further updated.

(Subjunction 7)

The fault-tolerant system according to Subjunction 5, wherein:

the second storer stores in the second storage region data in the small region corresponding to the flag set to dirty at a time when the checkpoint comes.

(Subjunction 8)

The fault-tolerant system according to any one of Subjunction 4 to 7, wherein:

the small region is a memory page.

(Subjunction 9)

A memory control method, including:

a first storing step of storing data in a first storage region of a memory;

a second storing step of storing updated data in a second storage region different from the first storage region when data stored in the first storage region are updated;

a transfer step of transferring data stored in the second storage region to another system; and

a restriction step of restricting update of data in the second storage region during transfer in the transfer step.

(Subjunction 10)

A computer-readable recording medium storing programs allowing a computer to function as:

a first storer storing data in a first storage region of a memory;

a second storer storing updated data in a second storage region different from the first storage region when data stored in the first storage region are updated;

a transferer transferring data stored in the second storage region to another system; and

a restrictor restricting update of data in the second storage region during transfer by the transferer.

### INDUSTRIAL APPLICABILITY

The present invention is suitable for a fault-tolerant system.

Having described and illustrated the principles of this application by reference to one preferred embodiment, it should be apparent that the preferred embodiment may be modified in arrangement and detail without departing from the principles disclosed herein and that it is intended that the application be construed as including all such modifications and variations insofar as they come within the spirit and scope of the subject matter disclosed herein.

What is claimed is:

1. A fault-tolerant system, comprising:
a first storer storing data in a first storage region of a memory;
a second storer storing updated data in a second storage region different from said first storage region when data stored in said first storage region are updated;
a transferer transferring data stored in said second storage region to another system; and
a restrictor restricting update of data in said second storage region during transfer by said transferer.

2. The fault-tolerant system according to claim 1, wherein:
said second storer stores in said second storage region data in said first storage region that are updated by the next checkpoint since a given checkpoint; and
said transferer transfers data stored in said second storage region at each of said checkpoints.

3. The fault-tolerant system according to claim 1, further comprising:
a clearer clearing data that have been transferred by said transferer among the data stored in said second storage region.

4. The fault-tolerant system according to claim 2, further comprising:
a clearer clearing data that have been transferred by said transferer among the data stored in said second storage region.

5. The fault-tolerant system according to claim 1, wherein:
said second storer stores in said second storage region data in a small region having updated data among multiple small regions constituting said first storage region; and
said transferer transfers said data in a small region stored in said second storage region to another system.

6. The fault-tolerant system according to claim 2, wherein:
said second storer stores in said second storage region data in a small region having updated data among multiple small regions constituting said first storage region; and
said transferer transfers said data in a small region stored in said second storage region to another system.

7. The fault-tolerant system according to claim 3, wherein:
said second storer stores in said second storage region data in a small region having updated data among multiple small regions constituting said first storage region; and
said transferer transfers said data in a small region stored in said second storage region to another system.

8. The fault-tolerant system according to claim 5, further comprising:
a third storer storing flags corresponding to said small regions of said first storage region, respectively; and
a setter setting a flag corresponding to said small region having said updated data to dirty and setting the flags corresponding to said multiple small regions to clean when said restrictor restricts data update,
wherein said second storer stores in said second storage region data in said small region corresponding to said flag set to dirty.

9. The fault-tolerant system according to claim 6, further comprising:
a third storer storing flags corresponding to said small regions of said first storage region, respectively; and
a setter setting a flag corresponding to said small region having said updated data to dirty and setting the flags corresponding to said multiple small regions to clean when said restrictor restricts data update,
wherein said second storer stores in said second storage region data in said small region corresponding to said flag set to dirty.

10. The fault-tolerant system according to claim 7, further comprising:
a third storer storing flags corresponding to said small regions of said first storage region, respectively; and
a setter setting a flag corresponding to said small region having said updated data to dirty and setting the flags corresponding to said multiple small regions to clean when said restrictor restricts data update,
wherein said second storer stores in said second storage region data in said small region corresponding to said flag set to dirty.

11. The fault-tolerant system according to claim 8, wherein:
said second storage
stores in said second storage region data in said small region having said flag set to dirty each time said setter sets a flag corresponding to said small region having said updated data to dirty; and
similarly updates the data in said small region that are stored in said second storage region when the data in said small region having said flag set to dirty are further updated.

12. The fault-tolerant system according to claim 9, wherein:
said second storage
stores in said second storage region data in said small region having said flag set to dirty each time said setter sets a flag corresponding to said small region having said updated data to dirty; and
similarly updates the data in said small region that are stored in said second storage region when the data in said small region having said flag set to dirty are further updated.

13. The fault-tolerant system according to claim 10, wherein:
said second storage
stores in said second storage region data in said small region having said flag set to dirty each time said setter sets a flag corresponding to said small region having said updated data to dirty; and
similarly updates the data in said small region that are stored in said second storage region when the data in said small region having said flag set to dirty are further updated.

14. The fault-tolerant system according to claim 8, wherein:
said second storer stores in said second storage region data in said small region corresponding to said flag set to dirty at a time when said checkpoint comes.

15. The fault-tolerant system according to claim 9, wherein:
said second storer stores in said second storage region data in said small region corresponding to said flag set to dirty at a time when said checkpoint comes.

16. The fault-tolerant system according to claim 10, wherein:
said second storer stores in said second storage region data in said small region corresponding to said flag set to dirty at a time when said checkpoint comes.

17. The fault-tolerant system according to claim 5, wherein:
said small region is a memory page.

18. The fault-tolerant system according to claim 8, wherein:
said small region is a memory page.

19. A memory control method, including:
a first storing step of storing data in a first storage region of a memory;
a second storing step of storing updated data in a second storage region different from said first storage region when data stored in said first storage region are updated;
a transfer step of transferring data stored in said second storage region to another system; and
a restriction step of restricting update of data in said second storage region during transfer in said transfer step.

20. A computer-readable recording medium storing programs allowing a computer to function as:
a first storer storing data in a first storage region of a memory;
a second storer storing updated data in a second storage region different from said first storage region when data stored in said first storage region are updated;
a transferer transferring data stored in said second storage region to another system; and
a restrictor restricting update of data in said second storage region during transfer by said transferer.
